(19) United States
(12) Patent Application Publication
(10) Pub. No.: US 2013/0346176 A1
(43) Pub. Date: Dec. 26, 2013

(54) SYSTEM AND METHOD FOR PAYMENT INCENTIVIZING

(71) Applicants: Zachery Alolabi, Houston, TX (US); Stephen Moore, Houston, TX (US); Alexander De Ridder, Houston, TX (US)

(72) Inventors: Zachery Alolabi, Houston, TX (US); Stephen Moore, Houston, TX (US); Alexander De Ridder, Houston, TX (US)

(21) Appl. No.: 13/923,279

(22) Filed: Jun. 20, 2013

Related U.S. Application Data
(60) Provisional application No. 61/661,864, filed on Jun. 20, 2012.

(51) Int. Cl. G06Q 30/02

(52) U.S. Cl. CPC G06Q 30/0222
USPC 705/14.23

(57) ABSTRACT

The present invention generally relates to systems and methods for incentivizing payment means. Specifically, this invention relates to a system and method for incentivizing the use of cash payments for completion of in person transactions.

### CROSS-REFERENCE TO RELATED APPLICATIONS

This application claims the benefit of the following provisional application, each of which is hereby incorporated by reference in its entirety: U.S. Pat. App. No. 61/661,864 filed on Jun. 20, 2013.

### FIELD OF THE INVENTION

The present invention generally relates to systems and methods for incentivizing payment means. Specifically, this invention relates to a system and method for incentivizing the use of cash payments for completion of in person transactions.

### BACKGROUND

The options for making payments on purchases of goods and/or services has incrementally increased overtime. Payments to merchants other service providers (simply merchants for the purpose of this application) can be made in a variety of means and methods, each with their own advantages and disadvantages.

Methods for making payments include, but are not limited to, cash, checks, certified checks, money orders, automatic clearinghouse (ACH) payments, credit cards (e.g., American Express®, Visa®, Mastercard®), debit cards, online payment services (e.g., PayPal®, Bill-Me-Later®), wire transfer services. Frequently, merchants may be setup to accept some subset of these means.

Each payment source generally has its own advantages and disadvantages, both for the merchant and the consumer. Those advantages and disadvantages may change depending on the merchant, the consumer, the goods/services associated with the transactions, the location of the purchase, the timing of the purchase, or any combination thereof. For instance, cash may offer the best advantage for a merchant selling goods at a retail location due to the lowest transaction fee (zero, compared to percentages and transaction fees charged by credit card and debit card companies). However, if that same merchant was selling its goods at an event (e.g., concert), it may be more advantageous for transactions to be completed via debit card so the merchant does not have to make change and worry about carrying a large amount of cash in a relatively unsecure location and a debit card offers the lowest transaction of all non-cash payments.

Currently however, there is no way for a merchant to steer the payment habits of individuals other than manually ask each customer to use a specific type of payment means. Often, this is merely a request as the purchasing power lies with the consumer and the merchant can really only request the use of a specific payment source, the only other option being lose the sale.

Therefore, there is need in the art for a computer and web-based system and method for for incentivizing payment means. These and other features and advantages of the present invention will be explained and will become obvious to one skilled in the art through the summary of the invention that follows.

### SUMMARY OF THE INVENTION

Accordingly, it is an aspect of the present invention to provide a computer and web-based system and method for incentivizing payment means.

According to an embodiment of the present invention, a system for incentivizing payment means includes: a payment incentivizing module, comprising computer-executable code stored in non-volatile memory, a merchant module comprising computer-executable code stored in non-volatile memory, a processor, and a communications means, wherein the payment incentivizing module, the merchant module, the processor, and the communications means are operably connected and are configured to: determine a desired payment means for a payment transaction request; receive the payment transaction request from a user regarding a transaction with a merchant; transmit a desired payment means incentive code associated with the payment transaction request; receive confirmation from the merchant; generate one or more desired payment means incentive; and transmit the one or more desired payment means incentive.

According to an embodiment of the present invention, the transmission of the desired payment means incentive code is directed to the user.

According to an embodiment of the present invention, the transmission of the desired payment means incentive code is directed to the merchant.

According to an embodiment of the present invention, the transmission of one or more of the desired one or more payment means incentive is directed to the user.

According to an embodiment of the present invention, the transmission of one or more of the one or more desired payment means incentive is directed to the merchant.

According to an embodiment of the present invention, the desired payment means is determined via criteria provided by the merchant prior to receiving the payment transaction request.

According to an embodiment of the present invention, the system further includes a marketing center component, comprising computer-executable code stored in non-volatile memory, wherein the marketing center component, the payment incentivizing module, the merchant module, the processor, and the communications means are operably connected and are configured to provide the user with information regarding previously provided desired payment means incentives of the merchant.

According to an embodiment of the present invention, the marketing center component is provided information related to the one or more desired payment means incentives and updates the information regarding the previously provided desired payment means incentives.

According to an embodiment of the present invention, the desired payment means is selected from the group comprising, a credit card, a debit card, an automated clearing house transaction, a cash payment, a check payment, an electronic payment, a wire transfer, a bank transfer, and an electronic wallet payment.

According to an embodiment of the present invention, a method for incentivizing payment means, the method comprising the steps of: determining a desired payment means for a payment transaction request; receiving the payment transaction request from a user regarding a transaction with a merchant; transmitting a desired payment means incentive code associated with the payment transaction request; receiving confirmation from the merchant; generating one or more desired payment means incentive; and transmitting the one or more desired payment means incentive.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A illustrates a schematic overview of an exemplary cash payment incentivizing system, in accordance with an embodiment of the present invention;

FIG. 3B illustrates a schematic overview of an exemplary cash payment incentivizing system, in accordance with an embodiment of the present invention;

FIG. 4 illustrates a network schematic of a system, in accordance with an embodiment of the present invention;

FIG. 5 is a process flow for an exemplary cash payment incentivizing method, in accordance with an embodiment of the present invention; and

FIG. 6 is a process flow for an exemplary cash payment incentivizing method, in accordance with an embodiment of the present invention.

### DETAILED SPECIFICATION

The present invention generally relates to systems and methods for incentivizing payment means. Specifically, this invention relates to a system and method for incentivizing the use of cash payments for completion of in person transactions.

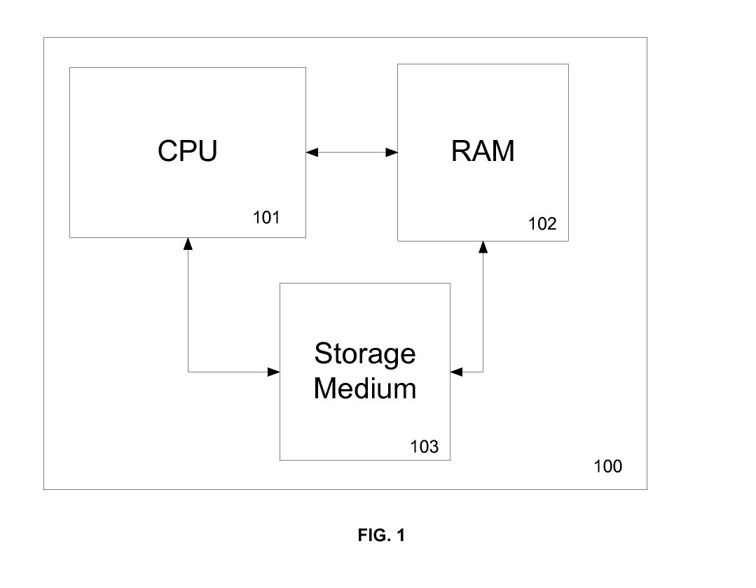

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks, wireless networks, near field communications) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

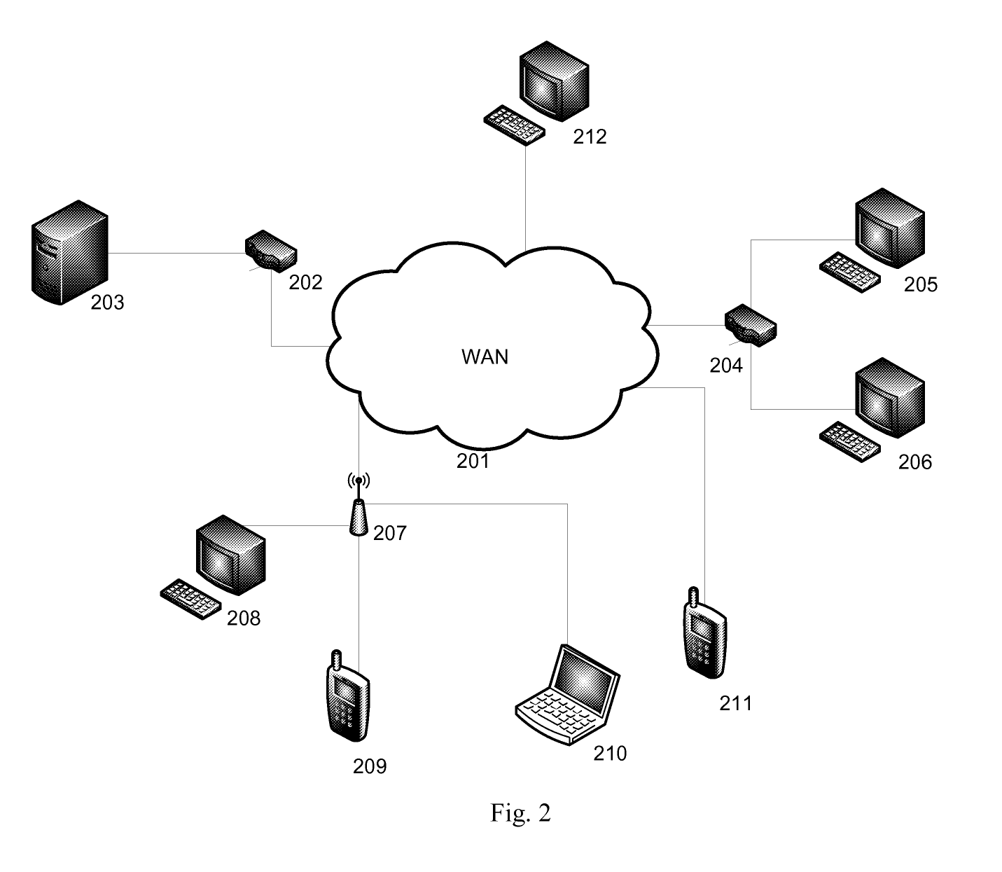

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

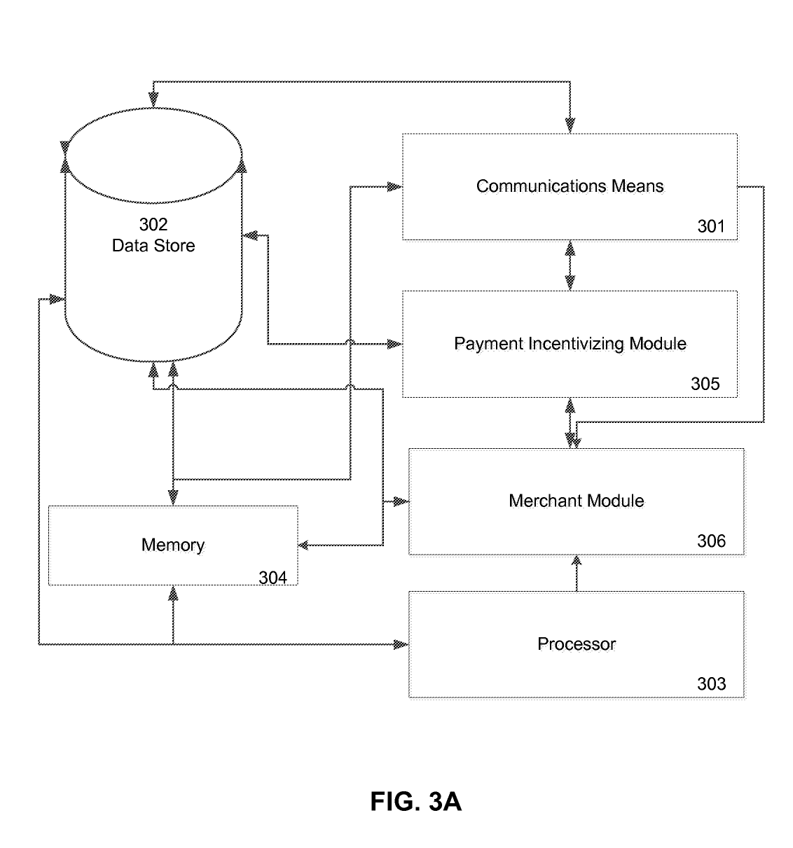

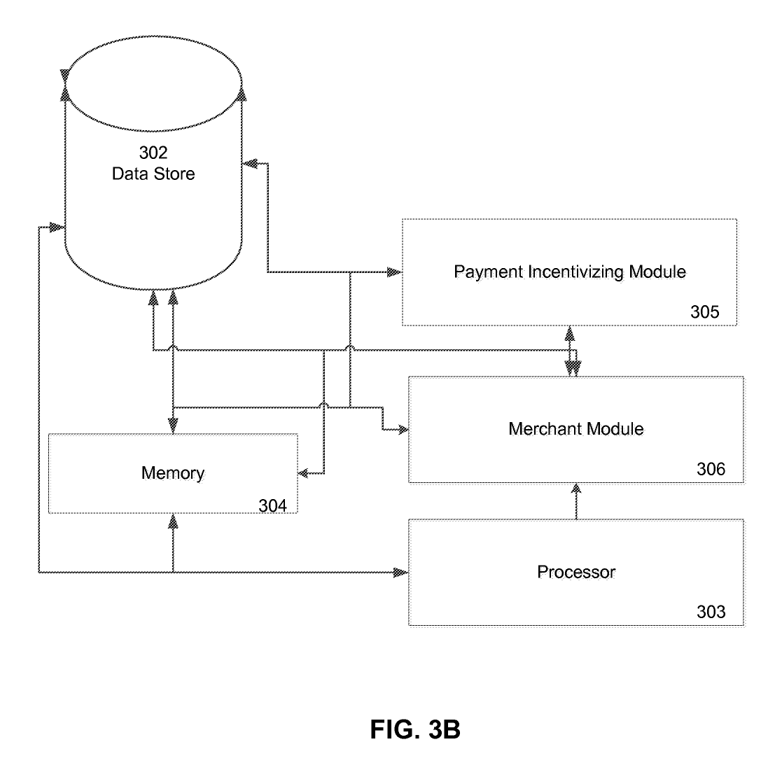

Turning to FIG. 3A, according to an embodiment of the present invention, a system for providing payment incentivizing is comprised of one or more communications means 301, one or more data stores 302, a processor 303, memory 404, a payment incentivizing module 305 and a merchant module 306. In alternate embodiments, the system may have additional or fewer components. For instance, as shown in FIG. 3B, the system may be comprised of one or more data stores 302, a processor 303, memory 404, a payment incentivizing module 305 and a merchant module 306. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the system is configured to provide users the ability to receive incentives for using a particular payment source during a checkout session. In a preferred embodiment, the system is configured to communicate with a computing device operated a user during an in-person checkout at a retailer or during another in-person commercial transaction. In this preferred embodiment, the system is configured to encourage the user to utilize cash as a payment means in order to complete the checkout or transaction. Cash payments often have beneficial ramifications for merchants (e.g., no credit/ACH processing fees). Therefore it is advantageous for merchants to encourage users to make cash payments.

While certain embodiments of the present invention may utilize systems and methods to encourage cash payments, alternative embodiments may encourage other payment means as well. For instance, encouraging debit transactions over credit transactions (as debit transactions typically have a significantly lower transaction fee than credit transactions). In other examples, credit card and debit card transactions may be preferred in situations where having a lot of cash on hand is undesirable. One of ordinary skill in the art would appreciate that there are numerous payment means and situations that could be incentive in accordance with embodiments of the present invention, and embodiments of the present invention are contemplated for use with incentivizing any payment means in any situation.

According to an embodiment of the present invention, the system may be engaged during the checkout or transaction process. In a preferred embodiment, when time for payment comes, the system may be utilized to engage the user to utilize a desired payment means. In conjunction with the selection of payment means, the system may be configured to generate an incentive for using the desired payment means. Incentives may include, but are not limited to, an immediate discount on the present transaction, a rebate, a coupon for future purchases, provision of a gift card, an entry into a contest, a chance to win an immediate prize or any combination thereof. One of ordinary skill in the art would appreciate that there are numerous types of incentives that may be offered by the system, and embodiments of the present invention are contemplated for use with any type of incentive.

According to an embodiment of the present invention, the system is configured to not only generate an incentive, but the incentive may be randomized. The addition of a randomized incentive increases the desirability of using the preferred payment means as the randomized incentive may be greater than the advertised or standard incentive. In an exemplary embodiment of the present invention, the consumers may be provided marketing center component, displayable on their computing device, where merchants can display both the offered incentive and the highest random incentive they have provided to their customers.

According to an embodiment of the present invention, the system may be configured to generate random incentives based on one or more data selection routines or randomization algorithms. For example, the system may be configured to provide a standard advertised incentive of a 5% refund when the consumer pays in cash; however, the system, as configured by the merchant, really allows an average of a 7% discount if paid the consumer pays with cash. In effect, the first 10 consumers may get a 5% discount but the 11th consumer gets a 19% discount for paying with cash. One of ordinary skill in the art would appreciate that there are numerous methods for generating a randomized percentage and tracking discount means and averages, and embodiments of the present invention are contemplated for use with any method for generating randomized percentages and tracking discount means and averages.

According to an embodiment of the present invention, the system may be controlled by an independent third party that is not affiliated or controlled by the merchant. In this configuration, the merchant and consumer interact with the third party system. One advantage of this configuration is that it provides an additional level of accountability as the merchant cannot “rig” these systems to generate less desirable incentives. Another advantage is that merchants and consumers can integrate into the system without requiring the outlay for building their own systems. Since a consumer may already have an application that communicates with the systems described herein, all the merchant needs to do in order to integrate with the application on the consumer's computing device is setup an account and provide incentive details to the system.

According to an embodiment of the present invention, the system may be configured to provide a transaction history for both merchant and consumer. In this manner, the system provides the merchant the ability to remarket to the incentivized customer if consumer wants more offers from the merchant. Further, the system provides the customer to have a comprehensive tracking of all payments. When utilized with cash as a payment means, the cash expenses may be tracked in the same manner as a credit card for accounting purposes. Additionally, the system may be configured to associate the name and number of the parties to the transaction so that the consumer can easily reconnect with merchant where they used the cash and vice versa.

According to an embodiment of the present invention, the system may be configured to assist in fraud and theft protection by allowing merchants who accept cash as a payment means by associating the identification information of the consumer that is linked to the incentivizing transaction. This may occur instantly when the consumer enters the cash amount in their computing device (e.g., smartphone), at which time a code is generated that is provided to the merchant and a variable rate discount is calculated for both the merchant and consumer to see.

In a preferred embodiment of the present invention, the system may be accomplished by one or more computing devices interacting with the computing device of a user. For instance, a terminal at the checkout of a retailer (e.g., cash register) may be configured to communicate with the mobile device of a user via one or more communications means (e.g., near field communications (NFC) means, RFIDs, wireless transmission means, infrared transmission means). In other embodiments, the user may initiate engagement with the system by entering or scanning a code (e.g., QR code, barcode) located at the terminal with the user's computing device, after which the user's computing device will communicate with the remote servers or other system components in order to receive the incentive. One of ordinary skill in the art would appreciate that there are numerous configurations between components of the system and the computing devices of users that may be utilized with embodiments of the present invention, and embodiments of the present invention are contemplated for use with any configuration.

According to an embodiment of the present invention, The system and methods herein described may be further comprised of a social structure and/or integration with one or more social networks. The system may be configured to provide users the ability to share deals with friends via one or more social networks or integrated social networking features. The system may be further configured to provide users the ability to share refund success (e.g., bragging). The system may be configured further to provide users the ability to review stores and provide other relevant social information.

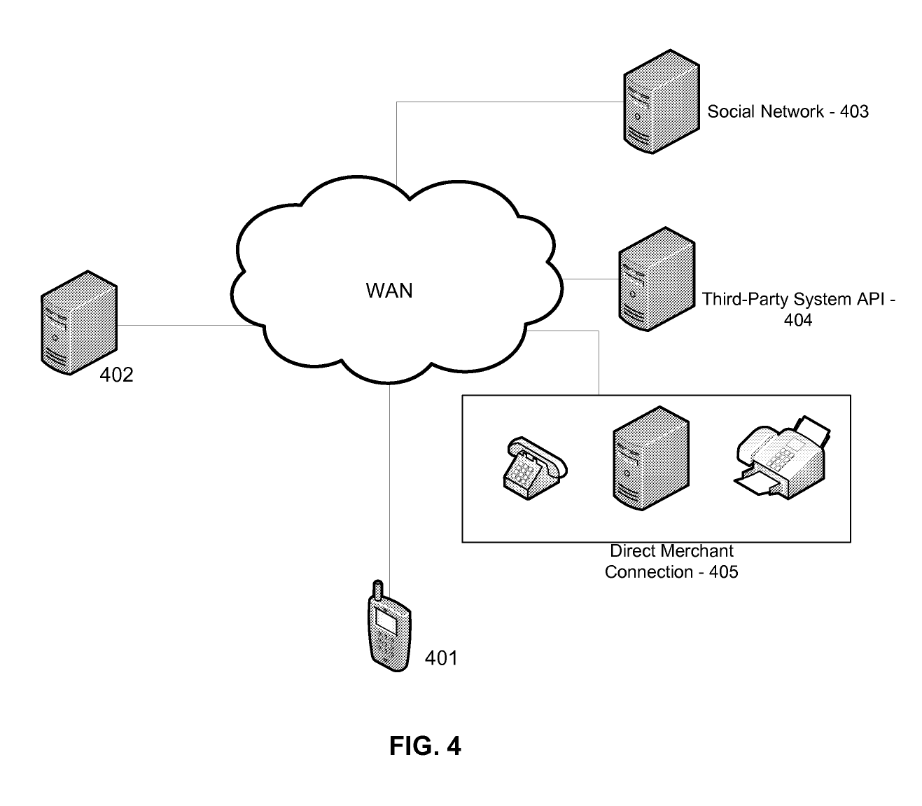

Turning now to FIG. 4, an expanded network schematic of a system in accordance with an embodiment of the present invention is shown. In FIG. 4, the system is shown as it may interact with merchants, users and other third party networks or APIs. For instance, a user of a mobile device 401 may be able to connect to application server 402. Application server 402 may be able to enhance or otherwise provide additional services to the user by requesting, sending and receiving information from one or more of a social network 403, a third party system API or other third party system 404, one or more direct merchant systems connections 405 (e.g., merchant's Point of Sale (POS) system, facsimile line, phone line) or any combination thereof. One of ordinary skill in the art would appreciate how accessing one or more third-party systems could augment the ability of the system described herein, and embodiments of the present invention are contemplated for use with any third-party system.

According to an embodiment of the present invention, the system may contain a marketing center component. In certain embodiments, the marketing center component may be integrated with the merchant module. In other embodiments, the marketing center component can be an independent module or otherwise integrated with another component of the system (e.g., payment incentivizing module). The marketing center component is configured to provide features to users (both consumers and merchants) that assist in providing marketing exposure for the merchants. For instance, the marketing center component may be configured to display to consumers the stores that give the highest discount incentives (e.g., higher discounts are propelled to the top of the shopping center searches). In preferred embodiments of the present invention, the marketing center component provides users to locate nearby merchants that utilize embodiments of the system. The marketing center component can provide a list of these merchants and sort the list via one or more characteristics (e.g., name, type, distance and incentives). The marketing center component may be further configured to notify users as to whether a certain merchant is a ‘lucky’ store (i.e., recently paid back a very high incentive, such as a 100% refund).

According to an embodiment of the present invention, the system may provide a registration component which is configured to allow a single merchant or multiple merchants to register with the system. In certain embodiments, the registration component may be integrated with the merchant module. In other embodiments, the registration component can be an independent module or otherwise integrated with another component of the system (e.g., payment incentivizing module). In the case of multiple merchants, the system may be configured to allow the merchants to register simultaneously. In this manner, merchants with unified interests (e.g., subsidiaries of a parent company) can instantaneously register and form symbiotic incentivizing programs specifically tailored to appeal to the audience the merchants may have in common. The registration component may be configured to collect information about each merchant and allow the system to gather and store pertinent information related to the merchants. One of ordinary skill in the art would appreciate that there are numerous types of pertinent information that could be utilized by embodiments of the present invention, and embodiments of the present invention are contemplated for use with any type of pertinent information.

### Exemplary Embodiment

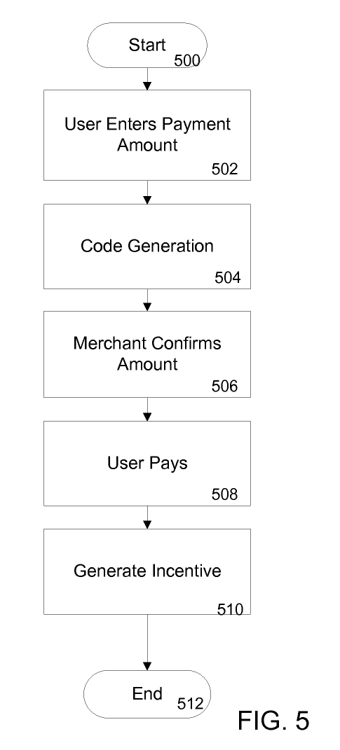

The following is an exemplary embodiment of a method for utilization of the system and method as described herein, as shown in FIG. 5. At step 500, the process starts with a user preparing to complete a payment transaction with a desired payment means. The determination of desired payment means may be done in a variety of manners. For instance, the determination may be preselected by the system, generated based on the items being purchased, generated based on user characteristics, generated based on transaction characteristics, retrieved from a data store or any combination thereof. One of ordinary skill in the art would appreciate that there are numerous methods for selecting the desired payment means, and embodiments of the invention are contemplated for use with any means for selecting the desired payment means.

At step 502, the payment transaction is initiated and the system is engaged by the ensuing payment transaction. The system receives a payment amount from the user. In a preferred embodiment of the present invention, the user provides the amount to the system via a connection between the system and software on the user's mobile computing device.

At step 504, the system generates and transmits to the user a code that identifies the transaction. The code is generated by the system and stored or held while waiting for merchant to confirm the code and amount. The code may be transmitted to the merchant automatically via a communications means (e.g., Bluetooth, NFC, RFID, WIFI). Alternatively, the code may be provided manually to the merchant by the user.

At step 506, the merchant confirms the amount with the system as related and associated to it by way of the code provided to the merchant in the previous step.

At step 508, the payment transaction is completed using the desired payment means between the user and the merchant.

At step 510, in the preferred embodiment, the system is informed of the completed transaction and generates and transmits the incentive to the user. Depending on the type of incentive, the incentive may be used immediately (e.g., cash back refunds) or provided for later use (e.g., coupons, gift cards). In preferred embodiments of the present invention, the system is configured to provide a cash back incentive immediately to the user. This allows the system to provide users with instant gratification.in conjunction with the random factor (i.e., the cash back incentive is variable) creating a very powerful psychological component that increases the chance the users will repeatedly and frequently utilize the system. After the incentive has been provided, the process completes at step 512.

In certain embodiments of the present invention, the incentives generated and provided during a transaction may be for two or more separate merchants. For instance, the consumer may complete the process as outlined in FIG. 5 and at step 510 the system may generate two incentives, the first a cash back refund incentive at the merchant where the transaction is being completed and the second incentive could be a discount for another merchant. In an exemplary embodiment, the second or further incentives could be for merchants in the immediate vicinity of the first merchant. In this manner, the consumer may be encouraged to shop at other retailers right away. This is convenient for the consumer and beneficial to the local merchants.

In another exemplary embodiment, from customer's point of view, the customer may be provided the ability to log in to get a record of their transaction. The customer can then request a refund from the merchant by entering in identifying information (e.g., the name of the merchant, the location, the amount of the sale, a transaction number). The system then generates a code (e.g., numerical, barcode, QR code, NFC, RFID). The consumer may then provide the code to the merchant and the merchant enters that code in their system. Alternatively, the computing device of the consumer may automatically provide the code to a computing device of the merchant. The system then “matches” the consumer with the merchant automatically and the merchant (i.e., computing device of the merchant) can confirm the transaction (e.g., amount the customer typed in). Then, the system automatically calculates the discount and transaction records are created for both the customer and merchant. Finally, marketing center stats are updated.

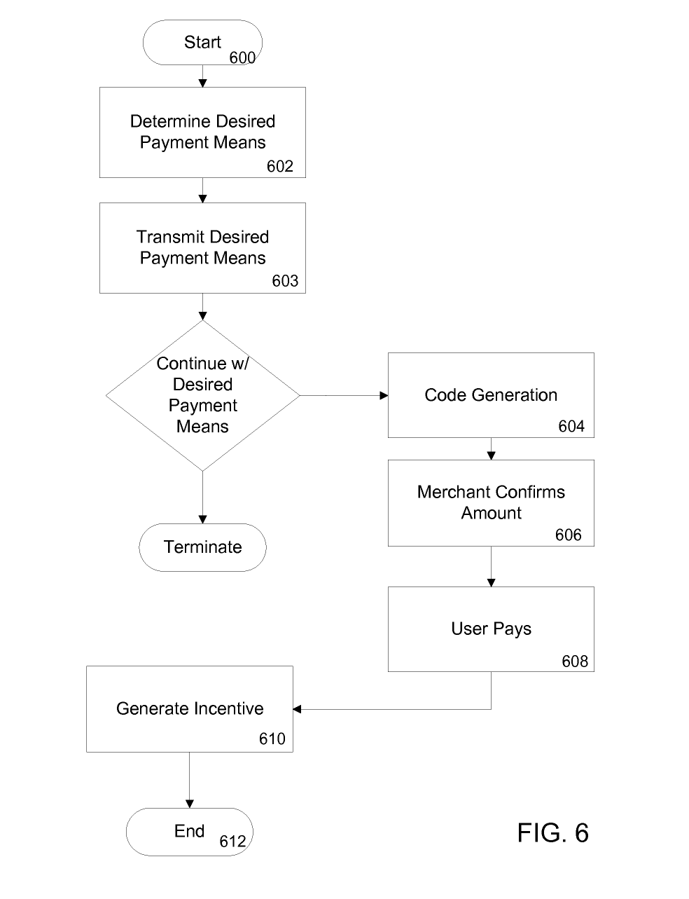

The following is another exemplary embodiment of a method for utilization of the system and method as described herein, as shown in FIG. 6. At step 600, the process starts with a user preparing to complete a payment transaction. At step 602, the system is configured to determine the desired payment means and alert the user of the appropriate desired payment means. For instance, the determination may be preselected by the system, generated based on the items being purchased, generated based on user characteristics, generated based on transaction characteristics, retrieved from a data store or any combination thereof. One of ordinary skill in the art would appreciate that there are numerous methods for selecting the desired payment means, and embodiments of the invention are contemplated for use with any means for selecting the desired payment means.

At step 603, the system transmits the desired payment means selection to the user. Assuming the user desires to continue with the desired payment means and receive an associated incentive, the process will continue. Otherwise, the process will terminate.

At step 604, the system generates and transmits to the user a code that identifies the transaction. The code is generated by the system and stored or held while waiting for merchant to confirm the code and amount. The code may be transmitted to the merchant automatically via a communications means (e.g., Bluetooth, NFC, RFID, WIFI). Alternatively, the code may be provided manually to the merchant by the user.

At step 606, the merchant confirms the transaction with the system as related and associated to it by way of the code provided to the merchant in the previous step.

At step 608, the payment transaction is completed using the desired payment means between the user and the merchant.

At step 610, in the preferred embodiment, the system is informed of the completed transaction and generates and transmits the incentive to the user. Depending on the type of incentive, the incentive may be used immediately (e.g., cash back refunds) or provided for later use (e.g., coupons, gift cards). In preferred embodiments of the present invention, the system is configured to provide a cash back incentive immediately to the user. This allows the system to provide users with instant gratification.in conjunction with the random factor (i.e., the cash back incentive is variable) creating a very powerful psychological component that increases the chance the users will repeatedly and frequently utilize the system. After the incentive has been provided, the process completes at step 612.

In certain embodiments of the present invention, the incentives generated and provided during a transaction may be for two or more separate merchants. For instance, the consumer may complete the process as outlined in FIG. 6 and at step 610 the system may generate two incentives, the first a cash back refund incentive at the merchant where the transaction is being completed and the second incentive could be a discount for another merchant. In an exemplary embodiment, the second or further incentives could be for merchants in the immediate vicinity of the first merchant. In this manner, the consumer may be encouraged to shop at other retailers right away. This is convenient for the consumer and beneficial to the local merchants.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for incentivizing payment means, the system comprising:
a payment incentivizing module, comprising computer-executable code stored in non-volatile memory,
a merchant module comprising computer-executable code stored in non-volatile memory,
a processor, and
a communications means,
wherein said payment incentivizing module, said merchant module, said processor, and said communications means are operably connected and are configured to:
determine a desired payment means for a payment transaction request;
receive said payment transaction request from a user regarding a transaction with a merchant;
transmit a desired payment means incentive code associated with said payment transaction request;
receive confirmation from said merchant;
generate one or more desired payment means incentive; and
transmit said one or more desired payment means incentive.

2. The system of claim 1, wherein said transmission of said desired payment means incentive code is directed to said user.

3. The system of claim 1, wherein said transmission of said desired payment means incentive code is directed to said merchant.

4. The system of claim 1, wherein said transmission of one or more of said desired one or more payment means incentive is directed to said user.

5. The system of claim 1, wherein said transmission of one or more of said one or more desired payment means incentive is directed to said merchant.

6. The system of claim 1, wherein said desired payment means is determined via criteria provided by said merchant prior to receiving said payment transaction request.

7. The system of claim 1, further comprising a marketing center component, comprising computer-executable code stored in non-volatile memory, wherein said marketing center component, said payment incentivizing module, said merchant module, said processor, and said communications means are operably connected and are configured to provide said user with information regarding previously provided desired payment means incentives of said merchant.

8. The system of claim 7, wherein said marketing center component is provided information related to said one or more desired payment means incentives and updates said information regarding said previously provided desired payment means incentives.

9. The system of claim 1, wherein the desired payment means is selected from the group comprising, a credit card, a debit card, an automated clearing house transaction, a cash payment, a check payment, an electronic payment, a wire transfer, a bank transfer, and an electronic wallet payment.

10. A method for incentivizing payment means, said method comprising the steps of:
determining a desired payment means for a payment transaction request;
receiving said payment transaction request from a user regarding a transaction with a merchant;
transmitting a desired payment means incentive code associated with said payment transaction request;
receiving confirmation from said merchant;
generating one or more desired payment means incentive; and
transmitting said one or more desired payment means incentive.

11. The method of claim 10, wherein said transmission of said desired payment means incentive code is directed to said user.

12. The method of claim 10, wherein said transmission of said desired payment means incentive code is directed to said merchant.

13. The method of claim 10, wherein said transmission of one or more of said desired one or more payment means incentive is directed to said user.

14. The method of claim 10, wherein said transmission of one or more of said one or more desired payment means incentive is directed to said merchant.

15. The method of claim 10, wherein said desired payment means is determined via criteria provided by said merchant prior to receiving said payment transaction request.

16. The method of claim 10, further comprising a marketing center component, comprising computer-executable code stored in non-volatile memory, wherein said marketing center component, said payment incentivizing module, said merchant module, said processor, and said communications means are operably connected and are configured to provide said user with information regarding previously provided desired payment means incentives of said merchant.

17. The method of claim 16, wherein said marketing center component is provided information related to said one or more desired payment means incentives and updates said information regarding said previously provided desired payment means incentives.

18. The method of claim 10, wherein the desired payment means is selected from the group comprising, a credit card, a debit card, an automated clearing house transaction, a cash payment, a check payment, an electronic payment, a wire transfer, a bank transfer, and an electronic wallet payment.
